(19) United States
(12) Patent Application Publication
(10) Pub. No.: US 2005/0109221 A1
(43) Pub. Date: May 26, 2005

(54) Food product and method of making same

(76) Inventor: Wen Jey Chang, Barrington, IL (US)

Correspondence Address: FUZAIL & ASSOCIATES, P.C., 2413 Baldwin Court, Schaumburg, IL, 60193, US

(21) Appl. No.: 10/967,598

(22) Filed: Oct. 18, 2004

Related U.S. Application Data
(60) Provisional application No. 60/512,517, filed on Oct. 18, 2003.

(51) Int. Cl. A21C 9/06

(52) U.S. Cl. 99/450.6

(57) ABSTRACT

The present invention provide a food product comprising an edible filling material, a dough sheet encasing said edible filling material, the dough sheet being rolled upon itself at least after encasing said filling material, and a handle having a distal end region and a proximal end region, the distal end region of the handle being placed between layers of the dough sheet before the dough sheet is rolled upon itself, wherein at least the distal end region of said handle is substantially coated with an edible biocompatible adhesive solution before being placed between the layers of the dough sheet, and wherein upon deep frying said food product the distal end region of the handle becomes affixed to the dough sheet. A method of making said food product is also provided herein.

This application claims the benefit of U.S. Provisional Application Ser. No. 60/512,517 filed Oct. 18, 2003.

### FIELD OF THE INVENTION

The present invention is directed to a food product, and more specifically, to an egg-roll affixed to a handle for consumption by a person without having to directly contact the egg-roll, and a method of making same.

### BACKGROUND OF THE INVENTION

Food products wherein a stuffing is enveloped in a baked or deep fried dough wrapper, sheet or leaf are known. Such products include, for example, egg-rolls, chimichangas, spring-rolls and the like. When consuming such food products, a consumer can either eat them with his or her hands or using utensils such as a fork and knife. This is often not practical because when directly contacting a deep fried food, the consumer's hand or fingers will become coated with oil. The consumer then has to wash his or her hands to remove the oil coating. Also, if a person is on the go utensils are not readily available to eat food products. If utensils are available both hands have to be used to hold down the food and to cut it into small pieces for easy consumption.

Therefore, what is needed is a food product such as, for example, an egg-roll which can be consumed by a consumer without directly contacting it.

### SUMMARY OF THE INVENTION

The present invention provide a food product comprising an edible filling material, a dough sheet encasing said edible filling material, the dough sheet being rolled upon itself at least after encasing said filling material, and a handle having a distal end region and a proximal end region, the distal end region of the handle being placed between layers of the dough sheet before the dough sheet is rolled upon itself, wherein at least the distal end region of said handle is substantially coated with an edible biocompatible adhesive solution before being placed between the layers of the dough sheet, and wherein upon deep frying said food product the distal end region of the handle becomes affixed to the dough sheet.

The present invention also provides a method of making a food product comprising the steps of (a) placing an edible filling material in the center of a dough sheet, (b) folding all but one portion of the dough sheet over the filling material to encase the filling material, (c) placing on an unfolded portion of the dough sheet a distal end region of a handle, the handle having a distal end region and a proximal end region, wherein at least the distal end region of the handle is coated with an edible biocompatible adhesive solution before placing on the unfolded portion of the dough sheet, (d) folding the unfolded portion of the dough sheet over to completely encase the filing material providing a completely folded food product; and (e) deep frying the completely folded food product for a predetermined amount of time until the distal end region of the handle is adhered to the food product.

### BRIEF DESCRIPTION OF THE FIGURES

In the drawings,

FIG. 1 is a perspective view of food product 100;

FIG. 2 is a cross-sectional view taken along line 2 of FIG. 1;

FIG. 3 is a top plan view of a square or rectangular dough sheet 10;

FIG. 4 is a top plan view of dough sheet 10 with filling material placed in the center of it;

FIG. 5 is a top plan view of dough sheet 10 having a first 50a folded over filling material 60;

FIG. 6 is a top plan view of dough sheet 10 having second corner 50b and third corner 50c folded over first corner 50a;

FIG. 7 is a perspective view of the distal region 70a of handle 70 immersed in a flour and water solution;

FIG. 8 is a top plan view of the distal region 70a of handle 70 placed upon the inner surface 20 of the fourth corner region 80;

FIG. 9 is a top plan view of filled dough sheet 10 rolled again towards the fourth corner 50d sandwiching the distal region 70a of handle 70 and encapsulating filing material 60;

FIG. 10 is a top plane view of dough sheet 10 with elongated filling material placed in the center of it; and

FIG. 11 is a top plan view of food product 100 wherein the dough sheet 10 is circular.

### DETAILED DESCRIPTION OF THE INVENTION

Turning now to the drawings, and in particular FIG. 3, one embodiment of the present invention provides a square or rectangular dough sheet 10 having an inner surface 20 and an outer surface 30. The dough sheet 10 having a center region 40 of the inner surface 20 and four corners, namely, 50a, 50b, 50c and 50d. A filling material 60 is placed on the center region 40 shown in FIG. 4 and the first corner, 50a, is folded over the filling material as shown in FIG. 5. Second corner, 50b, and third corner, 50c, are then folded over first corner 50a as shown in FIG. 6.

A distal region 70a of wooden handle 70 shown in FIG. 7 is treated with an ingestible biocompatible adhesive solution 200 comprising flour and water wherein the flour and water is in a ratio of about 3 parts flour to about 10 parts water. The distal region 70a of handle 70 is dipped in the adhesive solution 200 until it is substantially coated with said adhesive solution. The coated distal region 70a of handle 70 is then placed on the inner surface 20 of the dough sheet 10 at the fourth corner region 80 as shown in FIG. 8. In one embodiment, the wooden handle 70 is comprised of white birch. It is contemplated, however, that other type of wood can be used to form the wooden handle 70.

The folded dough sheet 10 partially enveloping the filling material 60 is the rolled toward the fourth corner 50d, or fourth corner 50d is folded over the first, second and third corners as shown in FIG. 9. At this point, the filling material 60 is totally enclosed within the dough sheet 10, and the distal region 70a of handle 70 is sandwiched between the inner surface 20 of the fourth corner region 80 and the filled dough sheet as shown in FIG. 2.

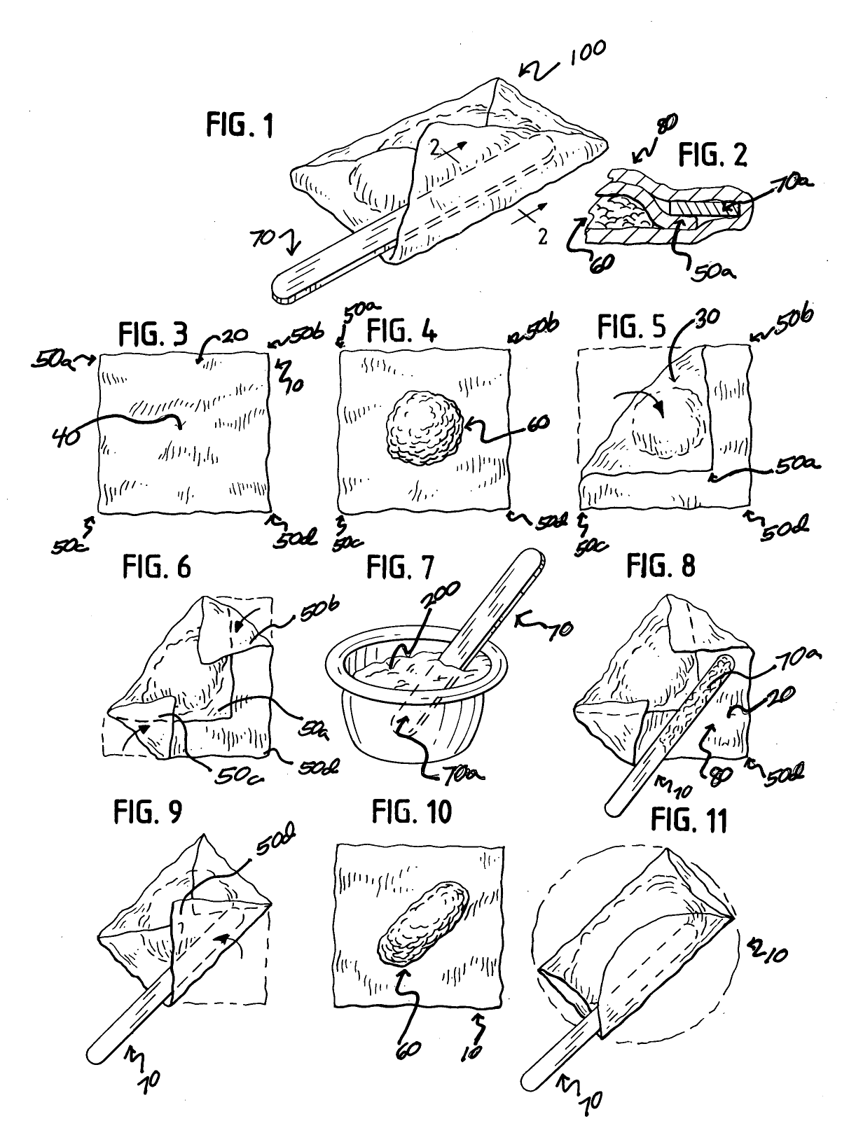

The filled dough sheet 10 is then deep fried in oil for a pre-desired period of time until the dough sheet and filling are cooked to provide a deep fried filled dough sheet food product 100 having an exposed proximal handle region 70b of handle 70 as shown in FIG. 1. The coated region 70a of handle 70 adheres to the filled dough sheet 10 during the deep frying process such that it cannot be pulled out. May different types of cooking oils can be used such as vegetable oil, corn oil, olive oil, peanut oil, canola oil and the like. In one embodiment, peanut oil is used to deep fry the dough sheet stuffed with filling and having the handle placed between the dough sheets to be adhered during the deep frying process, and the temperature of the peanut oil can be in the range of about 300 degrees Fahrenheit to about 375 Fahrenheit degrees, and more preferably about 350 degrees Fahrenheit to about 365 Fahrenheit degrees, and most preferably about 365 degrees Fahrenheit. The filled dough sheet should ideally be cooked until it reaches a golden brown color. The time it takes to achieve this coloration is dependent upon the type and temperature of the oil being used.

A consumer can then eat the deep fried filled dough sheet food product 100 by holding the proximal handle region 70b and avoid directly contacting the deep fried filled dough sheet food product thus preventing oil from coating his or her hands and/or fingers.

While one embodiment of the present invention has been described above, the invention should not be construed as limited thereto. For example, the adhesive solution maybe comprised of biocompatible consumable materials other than flour and water which also provide sufficient adhesion to the deep fried filled dough sheet food product so as not to be removable. Moreover, when said adhesive solution is comprised of flour and water, the ratios of either component are variable so long as they ratios provide the adhesive quality to provide food product 100.

In another embodiment, the dough sheet 10 maybe round rather than square or rectangular as shown in FIG. 11. In yet another embodiment, the handle 70 may be constructed of other materials which can withstand being deep fried and provide the adhering quality described above when treated with said adhesive solution. In a further embodiment, the filling material 60 may be elongated as shown in FIG. 10.

1. A food product comprising:
a) an edible filling material;
b) a dough sheet encasing said edible filling material, the dough sheet being rolled upon itself at least after encasing said filling material; and
c) a handle having a distal end region and a proximal end region, the distal end region of the handle being placed between layers of the dough sheet before the dough sheet is rolled upon itself, wherein at least the distal end region of said handle is substantially coated with an edible biocompatible adhesive solution before being placed between the layers of the dough sheet, and wherein upon deep frying in oil said food product the distal end region of the handle becomes affixed to the dough sheet.

2. The food product of claim 1 wherein the adhesive solution comprises flour and water.

3. The food product of claim 2 wherein the flour and water are in a ration of about 3 parts flour to about 10 parts water.

4. The food product of claim 1 wherein the handle is comprised of wood.

5. The food product of claim 4 wherein the wood is white birch.

6. The food product of claim 1 wherein the oil is selected from the group consisting of vegetable oil, corn oil, olive oil, peanut oil, canola oil and the like.

7. The food product of claim 6 wherein the oil is peanut oil.

8. A method of making a food product comprising the steps of:
a) placing an edible filling material in the center of a dough sheet;
b) folding all but one portion of the dough sheet over the filling material to encase the filling material;
c) placing on an unfolded portion of the dough sheet a distal end region of a handle, the handle having a distal end region and a proximal end region, wherein at least the distal end region of the handle is coated with an edible biocompatible adhesive solution before placing on the unfolded portion of the dough sheet;
d) folding the unfolded portion of the dough sheet over to completely encase the filing material providing a completely folded food product; and
e) deep frying the completely folded food product for a predetermined amount of time until the distal end region of the handle is adhered to the food product.

9. The food product of claim 8 wherein the edible biocompatible adhesive solution comprises flour and water.

10. The food product of claim 9 wherein the flour and water are in a ration of about 3 parts flour to about 10 parts water.

11. The food product of claim 8 wherein the handle is comprised of wood.

12. The food product of claim 11 wherein the wood is white birch.

13. The food product of claim 8 wherein the oil is selected from the group consisting of vegetable oil, corn oil, olive oil, peanut oil, canola oil and the like.

14. The food product of claim 13 wherein the oil is peanut oil.
